(19) United States
(12) Patent Application Publication
(10) Pub. No.: US 2016/0231729 A1
(43) Pub. Date: Aug. 11, 2016

(54) PHOTOELECTRIC BARRIER WITH IMPROVED SAFETY, IN PARTICULAR FOR CUTTING MACHINES

(71) Applicant: Atom S.p.A., Vigevano (PV) (IT)

(72) Inventor: Riccardo DEAMBROSIS, Vigevano (PV) (IT)

(21) Appl. No.: 15/018,988

(22) Filed: Feb. 9, 2016

(30) Foreign Application Priority Data
Feb. 10, 2015 (IT) MI2015U000028

(51) Int. Cl. G05B 19/406; B26D 7/22; G01V 8/10

(52) U.S. Cl. CPC G05B 19/406; G01V 8/10; B26D 7/22

(57) ABSTRACT

A photoelectric barrier with improved safety, especially although not critically for numerical control cutting machines or tables (10) provided with a work surface on which is placed the material to be cut by one or more cutting units (12) moved along at least one beam (14) extending transversely above the surface itself, comprises at least one optical or laser scanner sensor (20), stabilised to the same cutting machine or table (10) to constantly scan in two dimensions of the surrounding environment by means of laser beams.

### CROSS REFERENCE TO RELATED APPLICATIONS

This application claims priority to IT patent application No. MI2015U000028, filed Feb. 10, 2015, which is incorporated herein by reference thereto.

### FIELD OF INVENTION

The present invention relates to a photoelectric barrier with improved safety, especially suitable for cutting machines.

More particularly, the present invention relates to a safety barrier as defined above, advantageously usable on numerical control cutting machines typically intended for cutting semi-finished products in the field of footwear, leather goods, gaskets, technical fabrics, furnishings, automobiles, etc.

### BACKGROUND OF THE INVENTION

As is known, in the industrial production of leather goods in general, footwear and other articles, various machine tools are currently used that perform on the raw material, typically consisting of hides, leather, synthetic materials, paper, technical fabrics and the like in laminar form, many machining operations to obtain the semi-finished products to be assembled later and subjected to finishing. The cutting operation constitutes the basis of the work process and is carried out on special numerical control CNC cutting machines or tables; the work surface of such machines can be particularly extended to accommodate whole hides and is surmounted by at least one beam that supports one or more cutting units. During the work steps, an operator monitors the various movements of the operating units and of the related mobile supports to check that there are no problems such as to cause inaccuracies in the cut, with consequent production rejects.

These known machines, as well as other similar cutting machines, are provided with protection systems to prevent the assigned operator from the risk of accidents due to a distraction, fatigue or illness.

Various types are known that allow obtaining the necessary protections, which are substantially intended to prevent the hands or body parts of the operator from coming into contact with the moving parts of the machine. A first type of protection known for some time is constituted by a mechanical barrier, formed by an actual metal fence that perimetrically surrounds the machine and comprises one or more access areas constituted by sliding or removable panels; such panels are protected by micro-switches that are activated when the panels are opened or moved away during operation of the machine and stop it immediately. The main drawback of this system is the difficulty of creating a barrier so extensive and cumbersome around the machine and, consequently, the implementation costs.

Barriers are also known and widespread that do not involve the need to materially shield the machine with a fence for the entire perimeter, as they use photoelectric barriers or infrared photocells; in this case, an invisible protective field is created using infrared rays that delimits the area considered at risk and any interruption of a light beam, which the operator may inadvertently cause with a hand or other parts of the body, instantly generates a deactivation signal of the machine.

Even these protective systems, although effective, and much simpler than fences, are not free from drawbacks. In fact, as happens with said fences, even with the use of photoelectric barriers, the signal sent in the case of interruption of the light beam determines the instantaneous stoppage of the machine; this means that it is subsequently necessary to restore the operability of the production cycle, which can take time thus prolonging the machine downtime. Due to the sudden interruption of the cutting phase it may also happen that the semi-finished products are damaged and must be destroyed, thereby causing a further economic damage. In addition, the known photoelectric barriers are constituted, according to a widespread type, by columns extended vertically from the floor, in which are respectively arranged an emitter element and a receiver element of the rays or beam of rays. These columns are typically arranged in the vicinity of the vertices of the machine and at a certain distance from it, thus leading to a noticeable encumbrance with reduction of transit spaces, for example of internal handling equipment, in the vicinity of the machine itself.

### SUMMARY OF THE DISCLOSURE

The purpose of this invention is to overcome the drawbacks listed above.

More particularly, the purpose of the present invention is to provide a photoelectric barrier with improved safety that allows the creation around the machine or a part of it of at least two zones or contiguous protection fields, of which only the innermost and near to the machine instantaneously blocks its operation following the interruption of the light beam.

A further purpose of the invention is to provide a safety barrier as defined above wherein at least one zone or field external and contiguous to that next to the machine constitutes an alarm area, extended around the machine itself perimetrically or only for a part, to activate at least a warning signal without stopping all operation. Another purpose of the invention is to provide a safety barrier that does not create encumbrances around the machine to be protected.

A further purpose of the invention is to make available to users an improved safety barrier, especially for cutting machines, suitable to ensure a high level of strength and reliability over time, such as to be easily and economically constructed.

These and still other purposes are achieved by the barrier with improved safety of the present invention in accordance with the main claim.

### BRIEF DESCRIPTION OF THE DRAWINGS

The constructive and functional characteristics of the barrier with improved safety of the present invention will be better understood from the following detailed description, wherein reference is made to the accompanying drawings that illustrate a preferred and non-limiting embodiment and in which:

FIG. 1 is a schematic diagram of the barrier with improved safety of the present invention applied, by way of example, to a cutting machine, in particular to a table for cutting hides, leather and synthetic materials typically destined to the sectors of leather goods and footwear, gaskets, technical fabric, furniture and automobiles;

FIG. 2 is a schematic diagram of the barrier with improved safety of the present invention applied to a cutting machine, in particular a more limited part of said machine or table for cutting hides, leather and synthetic materials destined to the sector of leather goods and footwear.

### DETAILED DESCRIPTION OF THE INVENTION

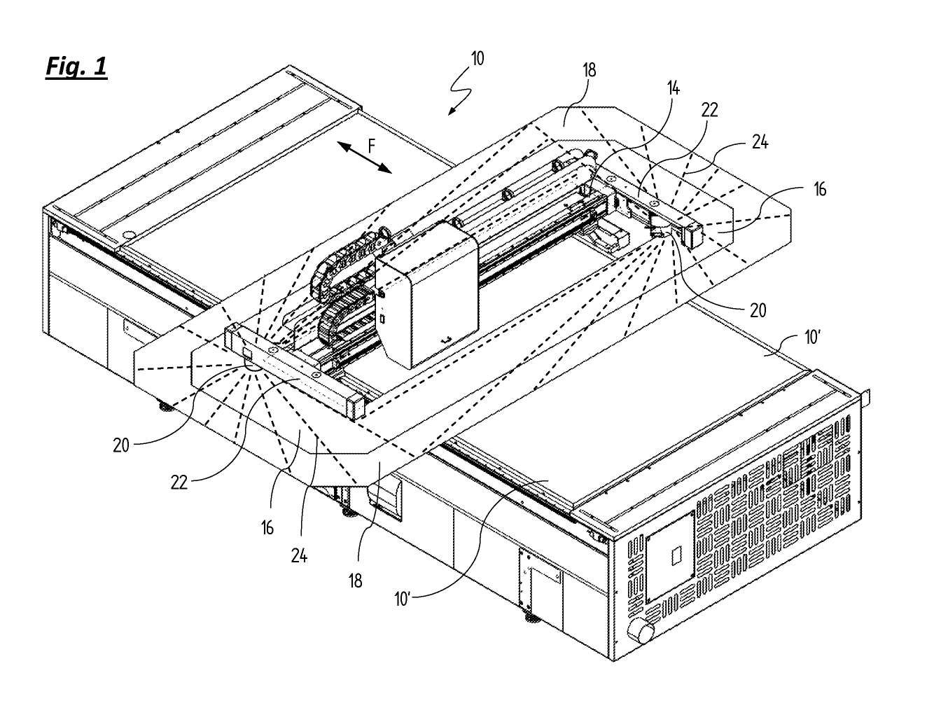

With initial reference to FIG. 1, the barrier with improved safety of the present invention is advantageously installed on a known cutting table 10, on the work surface of which is arranged the material to be cut using one or more cutting units 12, which are supported on, and slide along, a beam 14. The latter extends transversely over the table 10 and carries, in correspondence of each of the opposite ends, a sliding guide that cooperates with a corresponding guide present along the edge defined by the major sides 10′ of the table itself, so as to allow said beam 14 to move in the longitudinal direction, as indicated by arrow “F”.

According to the invention, the cutting machine or table 10 of the present invention is provided with one or more devices suitable to form a safety barrier around it, comprising at least one alarm zone well defined and programmable in terms of both shape and development/extension; in a particularly advantageous manner, said barrier comprises at least one protection or warning zone, extended outside the protection zone and contiguous to it. Said alarm and protection zones, schematically indicated respectively with 16 and 18 in FIG. 1, are formed through the use of at least one optical sensor or laser scanning device, commonly referred to as a “laser scanner”, which, suitably positioned in relation to the cutting machine or table 10, constantly scans in two dimensions of the surrounding environment through the emission of laser beams 24, generally in the infrared band, in such a way as to detect the optical radiation reflected from the surface of a possible body that engages one of said alarm zones. The sensors preferably used can be, by way of example, of the type known on the market with the designation S 300 Mini, produced by the German company Sick AG, and comprising a mirror that rotates at a constant speed and deflects the light pulses of the laser beams 24 to embrace a wide operating detection arc, typically of 270°. Said optical or laser scanner sensors are provided with an emitter and a receiver arranged in the same position inside the same device and allow defining and setting an alarm zone or field and one or more contiguous zones, external to the first, as for example a warning zone.

FIG. 1 schematically diagrams, by way of example, the situation in which, on a cutting table 10, has been defined an alarm zone 16 and an outer zone, but bordering with that of alarm, of warning 18. In a particularly advantageous way, said zones delimit only the moving parts of the machine 10, i.e., the beam 14 that supports the cutting unit 12. This is made possible by the fact that the optical sensors forming the photoelectric barrier with improved safety of the present invention are placed and stabilised in the vicinity of said beam 14, not requiring their location on a supporting element extending from the floor on which the machine 10 rests. In detail said sensors, indicated with 20, are fixed with brackets or equivalent known systems to one or more supports 22, each of which is in turn constrained in a known manner to one of the opposite ends of the beam 14. The supports 22 are generally constituted by a bar or a shaped metal profile, which extends above the cutting table 10 parallel to the major sides 10′ of the same. In particular, to each of the supports 22, is preferably stabilised a laser scanner sensor 20, in a position near or corresponding to the end opposite to the corresponding end of the other support 22, in such a way that each sensor 20 covers with its own field of action two sides of the perimeter around the beam 14 so as to form a continuous barrier all around the same. Said supports 22 can present a longitudinal extension variable as a function of the specific requirements related to the type of cutting machine or table 10.

In the moment in which the pulse or pulses of light emitted by a sensor or laser scanner hits a body in one of the areas or zones previously defined, the light is reflected from the surface of the body itself and returns to the same sensor. The time between the sending the pulse and receiving the return allows a processor to calculate the distance from said body and to detect if it is in the warning zone 18, for which one type of signal will be emitted, or if said body is located in the alarm zone 16, more internal with respect to the previous one and closer to the beam 14 which carries the cutting unit or units 12, so that a different signal will be emitted. Said emitted signals directly, or through a control unit of known type, activate the instantaneous blocking of the cutting machine or table if a body has been detected, typically a hand or an arm of an operator assigned to the process or equipment, in the alarm zone 16. If, instead, the body was detected in the warning zone 18, more external with respect to the previous and therefore farther from the beam 14 bearing the cutting unit or units 12, this signal can activate a sound and/or light signal, or slow down the movements of the beam 14 and the cutting unit(s) 12, without however completely blocking the machine 10. This, in particular, if the body was detected in a second warning zone 18 external and contiguous to that of alarm.

Obviously, this second type of alarm should prompt the operator to avoid further approach to the machine 10 and, in particular, to the beam 14, given that otherwise he would trip the second-level alarm and the machine would be instantly blocked. In any case, it can be foreseen that, if around the beam 14 two or more contiguous warning zones 18 are created, given that the laser scanners sensors allow it, such zones can be programmed with different functions, to slow down the movement of the moving parts of the machine or to emit audible or other different types of alarms and of progressively increasing intensity.

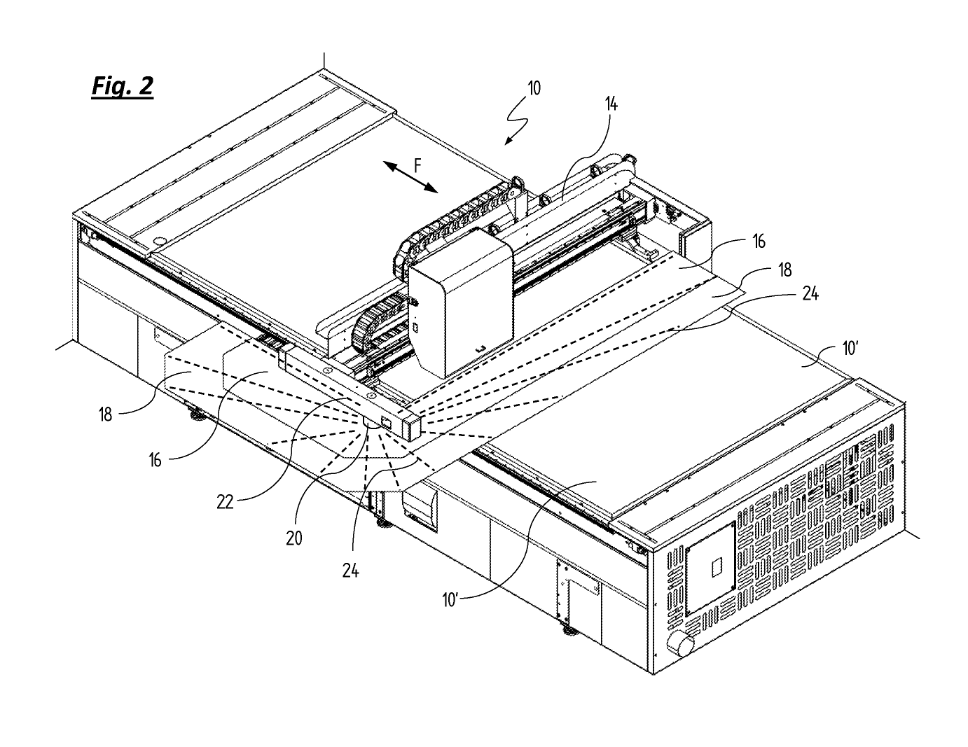

FIG. 2 schematically shows the possible situation in which, on the cutting table 10, there is provided only one support 22 with only one sensor 20; it follows, in this case, that the alarm 16 and warning 18 zones extend only around a half-part of the beam 14 that supports the cutting unit 12. A situation of this type can for example be advantageous in the case in which the machine or the cutting table are placed against or close to one or more angled walls, which excludes the possibility of passage in such zone by operators, and the resulting potential dangers.

As can be seen from the foregoing, the advantages achieved by the invention are clear.

The photoelectric barrier with improved safety of the present invention, provided on CNC numerical controlled cutting machines or tables and based on the use of one or pairs of laser scanner sensors 20, allows promptly detecting promptly a body in the area or possibly in the two contiguous warning areas 18 and to trigger an alarm signal or the activation of a machine function without the cutting operations in progress on the cutting machine or table being blocked. Moreover, in the case where the intrusion of the body should persist and involves the contiguous alarm zone 16, inside the previous and closer to the beam 14 and therefore more risky for the safety of people, the second-level alarm would be tripped, which would give rise to the instantaneous blocking of the machine itself.

Said improved photoelectric barrier, proposed by way of example in conjunction with cutting tables of the type illustrated in the figures, can, in any case, equip machines of other kinds, suitable for the cutting of any material.

Although the invention has been described above with reference to a specific embodiment, modifications and variants may be apparent to a person skilled in the art in light of the above description. Therefore, this invention intends to embrace all the modifications and variants falling within the spirit and scope of the following claims.

1. A photoelectric barrier with improved safety, especially although not critically for numerical control cutting machines or tables (10) provided with a work surface on which is placed the material to be cut by one or more cutting units (12) moved along at least one beam (14) extending transversely above the surface itself, the photoelectric barrier comprising at least one optical or laser scanner sensor (20), stabilised to the same cutting machine or table (10) to constantly scan in two dimensions of the surrounding environment by means of laser beams.

2. The photoelectric safety barrier according to claim 1, characterised in that said at least one laser scanner sensor (20) is stabilised to a support (22) bound to at least one of the opposite ends of the beam (14) along which is moved the cutting unit (12).

3. The photoelectric safety barrier according to claim 2, characterised in that each optical or laser scanner sensor (20) is stabilised on one end of the respective support (22) opposite to the corresponding end of the other support (22).

4. The photoelectric safety barrier according to claim 2, characterised in that said supports (22) are formed by a bar or shaped profile and each of them extends parallel to one of the major sides (10′) of the machine or cutting table (10).

5. The photoelectric safety barrier according to claim 1, characterised in that each optical or laser scanner sensor (20) defines, around said beam (14), a warning zone or field (16) and one or more contiguous zones, external to the first, of warning (18), to give rise respectively to the blocking of the cutting operations in progress on the machine (10) or one or more alarm signals, acoustic or of other type, in case of detection of a body in one or more of said zones by said sensors.

6. The photoelectric safety barrier according to claim 2, characterised in that said optical or laser scanner sensors (20) are arranged in correspondence or in proximity of the opposite ends of each of said supports (22).
